(19) United States
(12) Patent Application Publication
(10) Pub. No.: US 2025/0110339 A1
(43) Pub. Date: Apr. 3, 2025

(54) LIGHTGUIDE INCLUDING RIGHT-ANGLE LOUVER RETROREFLECTORS

(71) Applicant: GOOGLE LLC, Mountain View, CA (US)

(72) Inventors: Alexander Koshelev, San Jose, CA (US); Christophe Peroz, Zollikon (CH)

(21) Appl. No.: 18/903,976

(22) Filed: Oct. 1, 2024

Related U.S. Application Data
(60) Provisional application No. 63/587,614, filed on Oct. 3, 2023.

(51) Int. Cl. G02B 27/01

(52) U.S. Cl. CPC G02B 27/0172; G02B 2027/0178

(57) ABSTRACT

A lightguide for a head-wearable display or near-eye display includes an incoupler configured to direct display light representative of an image to the eye of a user. To direct the display light, the lightguide includes an incoupler that has reflectors configured to first direct the display light into the lightguide such that the display light propagates through the body lightguide and is received at a combined exit pupil expansion and outcoupling structure of the lightguide. This combined exit pupil expansion and outcoupling structure includes an array of louver retroreflectors that expands the eyebox of the image and also directs at least a portion of the display light out of the lightguide and toward the eye of the user. The louver retroreflectors in the array of louver retroreflectors each includes a first reflective surface and a second reflective surface arranged substantially orthogonal to each other.

### BACKGROUND

Certain head-wearable displays (HWDs) and near-eye displays (NEDs) are configured to present images to a user such that the images are viewable in a real-world space visible through the HWD or NED. To present such images to the user, these HWDs or NEDs direct light beams emitted from a projector to the user by using a lightguide that includes an incoupler and an outcoupler. This incoupler of a lightguide is configured to direct light emitted from a projector into the main body of the lightguide within which the light beams propagate by total internal reflection (TIR). The light beams then propagate through the lightguide until they are received at the outcoupler which directs the light beams out of the lightguide and toward the user such that images are presented to the user. To help increase the number of angles at which this image is visible to the user, certain HWDs or NEDs include a lightguide with an exit pupil expander (EPE) disposed between the incoupler and the outcoupler. The EPE is configured to split the display light so that additional beams of light are provided to the user which increases the number of angles at which this image is visible.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of an example display system including a lightguide with one or more right-angle louver retroreflectors, in accordance with some embodiments.

FIG. 2 is a block diagram of a projection system that projects images directly onto the eye of a user via display light, in accordance with some embodiments.

FIG. 3 is a diagram of an example lightguide with a combined exit pupil expansion and outcoupling structure, in accordance with embodiments.

FIG. 4 is a diagram of an example right-angle louver retroreflector, in accordance with embodiments.

FIG. 5 is a diagram of an example right-angle louver retroreflector having a cutout, in accordance with embodiments.

FIG. 6 is a diagram of an example array of right-angle louver retroreflectors for a combined exit pupil expansion and outcoupling structure, in accordance with embodiments.

FIG. 7 is a diagram of display light reflecting within an example array of right-angle louver retroreflectors, in accordance with embodiments.

FIG. 8 is a diagram of an example array of rotated right-angle louver retroreflectors for a combined exit pupil expansion and outcoupling structure, in accordance with some embodiments.

FIG. 9 is a diagram of an example layout for a lightguide including a combined exit pupil expansion and outcoupling structure, in accordance with some embodiments.

FIG. 10 is a diagram of a partially transparent view of a head-worn display (HWD) that includes a lightguide with one or more right-angle louver retroreflectors, in accordance with some embodiments.

### DETAILED DESCRIPTION

Some HWDs or NEDS (e.g., augmented reality head-worn displays) are designed to look like eyeglasses with at least one lens containing a lightguide to direct light to a user's eye. The combination of the lens and lightguide is referred to herein as an “optical combiner.” Such lightguides form, for example, incouplers, EPEs, and outcouplers that form and guide light to the user's eye. These HWDs or NEDS, for example, generally have a frame designed to be worn in front of a user's eyes to allow the user to view both their environment and computer-generated content projected from the combiner. Components that are necessary to the functioning of these HWDs or NEDs, such as, for example, an optical engine to project computer-generated content (e.g., display light representative of one or more images), cameras to pinpoint physical location, cameras to track the movement of the user's eye(s), processors to power the optical engine, and a power supply, are typically housed within the frame of the HWD or NEDS. As the frame for an HWD or NED has limited volume in which to accommodate these components, it is desirable that these components be as small as possible and configured to interact with the other components in very small volumes of space.

To guide light to a user's eye, some HWDs or NEDs include an optical engine configured to emit display light representing an image toward an incoupler of a lightguide. Such an incoupler, for example, includes one or more reflective facets (e.g., structures configured to reflect light) that provide the received light to a main body of the lightguide. The light then propagates through the main body of the lightguide using total internal reflection (TIR), partial internal reflection (PIR), or both until the light is received at an outcoupler of the lightguide. The outcoupler, for example, includes one or more reflective facets (e.g., structures configured to reflect light) that direct the light out of the lightguide and toward the eye of the user. As the light is directed out of the lightguide, the light forms one or more exit pupils a distance away from the lightguide that allow the user to view the image represented by the emitted light. The range of different user eye positions from which the user will be able to see the image is referred to herein as an “eyebox” of the image. To enlarge this eyebox, the lightguides of some HWDs or NEDs further include EPE disposed between the incoupler and the outcoupler of the lightguide. As the EPE receives the light propagating within the lightguide, reflective facets of EPE split the light into one or more beams in one or more directions and direct these split beams to the outcoupler. Due to the EPE splitting the light, additional exit pupils are formed, allowing additional user eye positions to view the image represented by the light and expanding the eyebox of the image. However, including an EPE in the lightguide requires additional space in the lightguide to accommodate the EPE. As such, including an EPE in the lightguide increases the size of the lightguide and the HWD or NED as a whole.

As such, systems and techniques disclosed herein are directed to a lightguide including right-angle louver retroreflectors that form a combined exit pupil expansion and outcoupling structure of a lightguide. For example, an HWD or NED includes one or more optical combiners that include a lightguide with an incoupler and a combined exit pupil expansion and outcoupling structure that operates as both an EPE and an outcoupler. The incoupler of the lightguide includes one or more reflective structures (e.g., reflective facets) configured to receive display light representing an image from a projector. Further, these reflective structures of the incoupler are configured to direct this display light such that the display light propagates through a main body of the lightguide via TIR, PIR, or both. The display light then propagates through the main body of the lightguide until it is received by the combined exit pupil expansion and outcoupling structure of the lightguide.

This combined exit pupil expansion and outcoupling structure of the lightguide is configured to both outcouple the display light to an eye of the user such that the user is able to see the image represented by the display light and expand the eyebox of the image. To this end, the combined exit pupil expansion and outcoupling structure of the lightguide includes one or more arrays of right-angle louver retroreflectors with each array having one or more rows and one or more columns. Each right-angle louver retroreflector, for example, includes a structure having a first reflective surface and a second reflective surface that together form a retroreflector. For example, within a right-angle louver retroreflector, the first and second reflective surfaces are arranged such that a side of the first reflective surface is joined with a side of the second reflective surface so that the first reflective surface and the second reflective surface are substantially orthogonal to each other. That is, a side of the first reflective surface is joined with a side of the second reflective surface so that the first reflective surface and the second reflective surface operate as if there was a right angle between them (e.g., together operate as a retroreflector). Where the side of the first reflective surface is joined with a side of the second reflective surface is referred to herein as the “edge” of the right-angle louver retroreflector. Due to a right-angle louver retroflector including two surfaces with a right angle between so as to operate as a retroreflector, light reflecting off the first surface and then the second surface would propagate in the same direction as light reflecting off the second surface and then the first surface. Because light reflects off the surfaces of the right-angle louver retroreflector in this way, the likelihood of a right-angle louver retroreflector in a combined exit pupil expansion and outcoupling structure producing double-images is reduced when compared to structures including other reflective structures.

Within an array, the right-angle louver retroreflectors are arranged such that the first reflective surfaces of the right-angle louver retroreflectors are substantially parallel and such that the second reflective surfaces of the right-angle louver retroreflectors are substantially parallel. Further, within the array, based on light being incident upon the first or second reflective surface of a right-angle louver retroreflector at a first angle or an angle in a first set of angles, the reflective surface reflects the light such that the light is received by the reflective surfaces of one or more other right-angle louver retroreflectors in the array. Based on light being incident upon the first or second reflective surface of a right-angle louver retroreflector at a second angle or a second set of angles, the reflective surface reflects the light out of the lightguide such that the light forms an exit pupil.

Additionally, within an array of right-angle louver retroreflectors, each row of right-angle louver retroreflectors is arranged such that the row of right-angle louver retroreflectors overlaps with at least a portion of one or more other rows of right-angle louver retroreflectors. For example, a first right-angle louver retroreflector of a first row is disposed such that at least a front portion of the first right-angle louver retroreflector is covered by at least a portion of a second right-angle-louver reflector of a second row. Further, as another example, the first right-angle louver retroreflector of the first row is disposed such that at least a back portion of the first right-angle louver retroreflector covers at least a portion of a third right-angle-louver reflector of a third row. Based on this arrangement, display light propagates through the main body of a lightguide and becomes incident upon multiple right-angle louver retroreflectors at a first angle or at an angle within a first range of angles which causes the right-angle louver retroreflectors to split the display light such that corresponding portions of the display are directed toward other right-angle louver retroreflectors in the array. Further, after reflecting off a right-angle louver retroreflector, a portion of the display light is then received at another right-angle louver retroreflector at a second angle or at an angle within a second set of angles which causes the right-angle louver retroreflector to direct the portion of the display light out of the lightguide such that the portion of the display light forms an exit pupil. Because the array of right-angle louver retroreflectors splits the display light, additional exit pupils are formed when the split portions of the display light are directed out of the lightguide which increases the size of the eyebox for the presented image. In this way, a lightguide is configured to include a combined exit pupil expansion and outcoupling structure using right-angle louver retroreflectors that occupies a single space within the lightguide. Additionally, because the lightguide includes a combined exit pupil expansion and outcoupling structure, the size of the lightguide is reduced when compared to lightguides having discrete exit pupil expansion and outcoupling structures that each have discrete spaces within the lightguide. Due to the size of the lightguide being decreased, the size of the HWD is also decreased, improving the form factor of the HWD or NED and user experience.

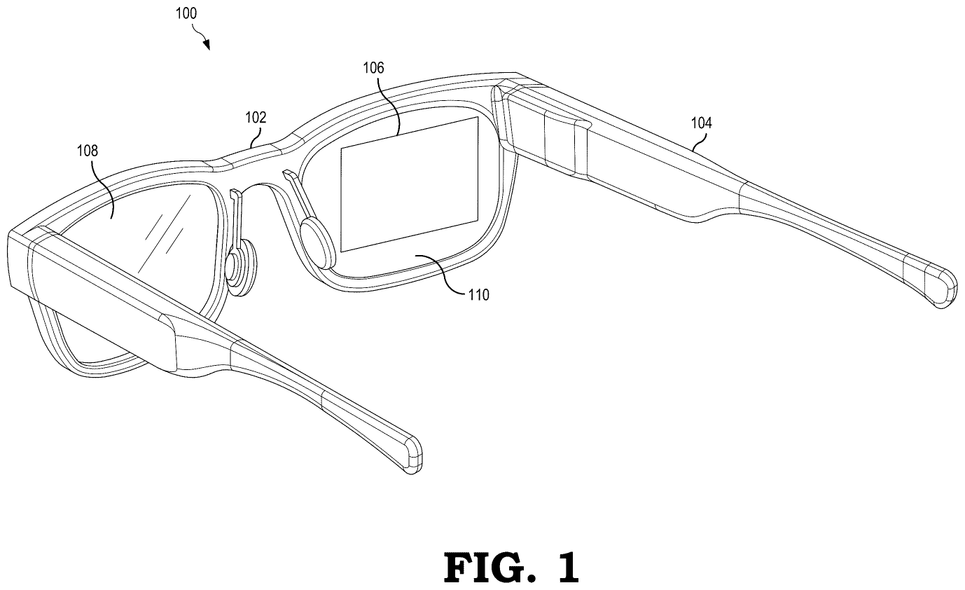

FIG. 1 illustrates an example display system 100 having a support structure 102 that includes an arm 104, which houses a projection system configured to project display light representative of images toward the eye of a user, such that the user perceives the images as being displayed in an FOV area 106 of a display at one or both of lens elements 108, 110. In the depicted embodiment, the display system 100 is an HWD that includes a support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., optical engine) and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in a region of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an extended reality (XR) display in which rendered graphical content can be superimposed over or otherwise provided in conjunction with a real-world view as perceived by the user through the lens elements 108, 110. For example, display light used to form a perceptible image or series of images may be projected (e.g., emitted) by a projector of the display system 100 onto the eye of the user via a series of optical elements, such as a lightguide formed at least partially in the corresponding lens element. One or both of the lens elements 108, 110 thus include at least a portion of a lightguide that routes display light received by an incoupler of the lightguide to a combined exit pupil expansion and outcoupling structure of the lightguide, which is configured to both enlarge the eyebox of the image to be displayed and outcouple the display light toward an eye of a user of the display system 100 so as to form multiple exit pupils. Such display light is modulated onto the eye of the user such that the user is able to view the image represented by the display light within an eyebox formed by the combined exit pupil expansion and outcoupling structure of the lightguide. To allow the combined exit pupil expansion and outcoupling structure of the lightguide to both enlarge the eyebox of an image represented by the display light and outcouple the display light, the combined exit pupil expansion and outcoupling structure includes an array of right-angle louver retroreflectors. A right-angle louver retroreflector, for example, includes a first reflective surface joined with a second reflective surface such that that the first reflective surface is substantially orthogonal to the second reflective surface (e.g., orthogonal within a tolerance of +/−5 arcmins). That is, the first reflective surface and second reflective surface operate as if there is a right angle between the first reflective surface and second reflective surface and the first reflective surface and the second reflective surface together operate as a retroreflector. When display light is received by such an array of right-angle louver retroreflectors, the display light is split into two or more portions (e.g., beams) that are then directed out of the lightguide such that multiple exit pupils are formed which expands the eyebox of the image. Further, each of the lens elements 108, 110 is sufficiently transparent to allow a user to see through the lens elements to provide an FOV area 106 of the user's real-world environment such that the image appears superimposed over at least a portion of the real-world environment.

In some embodiments, the projector is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The projector is communicatively coupled to the controller and a non-transitory processor-readable storage medium or a memory that stores processor-executable instructions and other data that, when executed by the controller, cause the controller to control the operation of the projector.

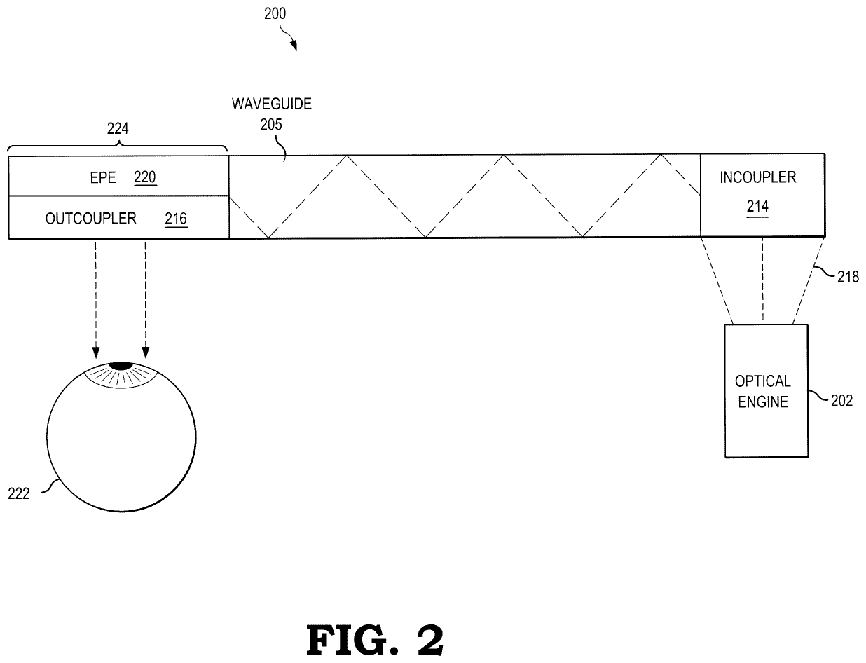

FIG. 2 illustrates a simplified block diagram of a projection system 200 that projects images directly onto the eye of a user via display light. The projection system 200 includes an optical engine 202 and a lightguide 205. The term “lightguide,” as used herein, will be understood to mean a combiner using one or more of TIR, PIR, specialized filters, and/or reflective surfaces, to transfer light from an incoupler (e.g., incoupler 214) to a combined exit pupil expansion and outcoupling structure (e.g., combined exit pupil expansion and outcoupling structure 224) that operates as both an outcoupler and an EPE. In some display applications, the light is a collimated image, and the lightguide transfers and replicates the collimated image to the eye. In some embodiments, the projection system 200 is implemented in a WHD or other display system, such as the display system 100 of FIG. 1.

The optical engine 202 includes one or more display light sources configured to generate and output display light 218 (e.g., visible display light such as red, blue, and green display light and/or non-visible display light such as infrared display light) representing an image. In some embodiments, the optical engine 202 is coupled to a driver or other controller (not shown), which controls the timing of emission of display light from the display light sources of the optical engine 202 in accordance with instructions received by the controller or driver from a computer processor coupled thereto to modulate the display light 218 to be perceived as images when output to the retina of an eye 222 of a user. For example, during the operation of the projection system 200, multiple display light beams having respectively different wavelengths are output by the display light sources of the optical engine 202, then combined via a beam combiner (not shown), before being directed to the eye 222 of the user. The optical engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time. Further, the lightguide 205 includes an incoupler 214 and a combined exit pupil expansion and outcoupling structure 224 that operates as both an outcoupler 216 and an EPE 220. Such a combined exit pupil expansion and outcoupling structure 224 is optically aligned with an eye 222 of a user in the present example. In some embodiments, the incoupler 214 has a substantially rectangular, circular, or elliptical profile and is configured to receive the display light 218. Further, the incoupler 214 is configured to direct display light representative of an image into the lightguide 205. To this end, the incoupler 214 includes one or more reflective facets configured to reflect and direct display light (e.g., display light 218) into the lightguide 205. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof.

According to embodiments, in response to receiving display light 218, the incoupler 214 is configured to provide the display light 218 to lightguide 205 such that the display light 218 propagates through lightguide 205 via TIR until it is received by the combined exit pupil expansion and outcoupling structure 224. As an example, the incoupler 214 provides display light 218 to lightguide 205 such that display light 218 performs one or more bounces (e.g., reflects off a surface of lightguide 205) before being received by the combined exit pupil expansion and outcoupling structure 224. After receiving display light 218, the combined exit pupil expansion and outcoupling structure 224 concurrently operates as an outcoupler 216 and EPE 220 and enlarges the eyebox of the image represented by display light 218 while also directing display light 218 out of the lightguide 205 and toward the eye 222 of the user. For example, the combined exit pupil expansion and outcoupling structure 224 includes an array of right-angle louver retroreflectors. These angle louver retroreflectors each include a first reflective surface joined with a second reflective surface such that the first reflective surface is substantially orthogonal to the second reflective surface (e.g., the first reflective surface and second reflective surface operate as a retroreflector). That is, the first reflective surface is orthogonal to the second reflective surface within a tolerance of, for example +/−5 arcmins. As display light 218 is received by an array of right-angle louver retroreflectors, the array of right-angle louver retroreflectors splits display light 218 into multiple portions (e.g., beams) and then directs these portions of display light 218 out of lightguide 205 and toward the eye 222 of the user such that multiple exit pupils form and the eyebox of the image is enlarged. These exit pupils, for example, each include the image represented by the display light 218 as emitted by optical engine 202 and refers to a corresponding location along the optical path where two or more beams of display light 218 intersect. As an example, the width (e.g., smallest dimension) of a given exit pupil approximately corresponds to the diameter of the display light 218 corresponding to that exit pupil. Accordingly, the exit pupil can be considered a “virtual aperture.”

Because lightguide 205 includes combined exit pupil expansion and outcoupling structure 224 that occupies a single space within the lightguide 205, the size of lightguide 205 is reduced when compared to lightguides that include distinct EPEs 220 and outcouplers 216. That is, because lightguide 205 includes a single structure for both an outcoupler 216 and EPE 220 that occupies a single space within the lightguide 205, the size of lightguide 205 is reduced when compared to lightguides having distinct structures and spaces for an EPE 220 and outcoupler 216. Due to the size of lightguide 205 being reduced, the size of an optical combiner implementing lightguide 205 is also reduced, which reduces the overall size of an HWD and improves user experience. According to embodiments, although not shown in the example of FIG. 2, in some embodiments additional optical components are included in any of the optical paths between the optical engine 202 and the incoupler 214, between the incoupler 214 and the combined exit pupil expansion and outcoupling structure 224, and/or between the combined exit pupil expansion and outcoupling structure 224 and the eye 222 (e.g., in order to shape the display light for viewing by the eye 222 of the user).

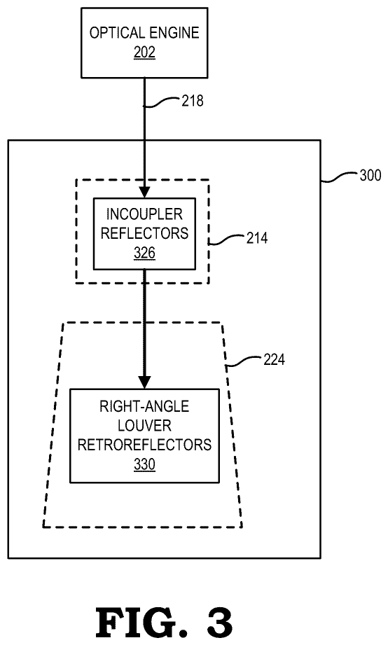

FIG. 3 illustrates an example lightguide 300 with a combined exit pupil expansion and outcoupling structure, according to embodiments. In embodiments, example lightguide 300 is implemented in, for example, display system 100 and is configured to provide an image to an eye 222 of a user while enlarging the eyebox of the image. To this end, example lightguide 300 includes an incoupler 214 and a combined exit pupil expansion and outcoupling structure 224. According to embodiments, optical engine 202 is configured to project display light 218 (e.g., light having one or more wavelengths associated with white light, green light, red light, blue light, infrared light, ultraviolet light, or any combination thereof) towards an incoupler 214 of example lightguide 300. After receiving display light 218, incoupler 214 is configured to guide display light 218 from incoupler 214 to combined exit pupil expansion and outcoupling structure 224 via at least a portion of example lightguide 300. For example, incoupler 214 guides display light 218 from incoupler 214 such that display light 218 propagates through at least a portion of example lightguide 300 via TIR, PIR, or both and is received at combined exit pupil expansion and outcoupling structure 224. To this end, incoupler 214 includes one or more incoupler reflectors 326 each configured to reflect display light 218 in one or more directions into a portion of example lightguide 300. Such incoupler reflectors 326, for example, include one or more reflective structures (e.g., mirrors, facets, coatings) disposed within example lightguide 300 and configured to reflect display light based on the angle of the reflective structures, the material of the reflective structures, or both into at least a portion of example lightguide 300.

In response to receiving display light 218 from incoupler 214, combined exit pupil expansion and outcoupling structure 224 is configured to both expand the exit pupil of the image represented by display light 218 and outcouple display light 218 so as to form multiple exit pupils. For example, combined exit pupil expansion and outcoupling structure 224 includes one or more right-angle louver retroreflectors 330 arranged, for example, in one or more arrays each having one or more rows and one or more columns. A right-angle louver retroreflector 330 includes a structure having two reflective surfaces arranged substantially orthogonal to on another (e.g., arranged so as to operate as a retroreflector due to the right angle between the reflective surfaces). As an example, a right-angle louver retroreflector 330 includes a first reflective surface disposed between the surfaces (e.g., TIR surfaces) of example lightguide 300 that includes one or more one or more reflective surfaces, reflective coatings (e.g., metallic coatings, multilayer dielectric coatings, mirrors (e.g., di-electric mirrors, metallic mirrors, Bragg facets), mirror coatings, or any combination thereof configured to reflect light based on the angle upon which the light was incident upon the first surface. Further, a right-angle louver retroreflector 330 includes a second reflective surface disposed between the surfaces (e.g., TIR surfaces) of example lightguide 300 that includes one or more one or more reflective surfaces, reflective coatings (e.g., metallic coatings, multilayer dielectric coatings, mirrors (e.g., di-electric mirrors, metallic mirrors, Bragg facets), mirror coatings, or any combination thereof configured to reflect light based on the angle upon which the light was incident upon the second surface. Within a right-angle louver retroreflector 330, a side of the first reflective surface is joined with a side of the second reflective surface such that the first reflective surface is substantially orthogonal to the second reflective surface (e.g., orthogonal within a tolerance of +/−5 arcmins). Due to a right-angle louver retroreflector 330 including two reflective surfaces that are substantially orthogonal to each other, the reflective surfaces together operate as a retroreflector. As such, light reflecting off the first reflective surface and then the second reflective surface would propagate in the same direction as light reflecting off the second reflective surface and then the first reflective surface. In light of this, the likelihood of a right-angle louver retroreflector 330 in the combined exit pupil expansion and outcoupling structure 224 producing double-images is reduced when compared to structures including different arrangements of reflective surfaces.

As display light 218 propagates through example lightguide 300, display light 218 becomes incident upon multiple right-angle louver retroreflectors 330 of an array within combined exit pupil expansion and outcoupling structure 224 at a first angle or an angle within a first range of angles. Due to display light being incident upon the right-angle louver retroreflectors 330 at a first angle or an angle within a first range of angles, the right-angle louver retroreflectors 330 split display light 218 into multiple portions (e.g., beams) which are then directed to other right-angle louver retroreflectors 330 within the array such that the portions are incident upon these other right-angle louver retroreflectors 330 at a second angle or an angle within a second range of angles. Because these portions are incident upon these right-angle louver retroreflectors 330 at a second angle or an angle within a second range of angles, the right-angle louver retroreflectors 330 direct the portions out of example lightguide 300 and toward the eye 222 of a user such that each portion forms a respective exit pupil which expands the eyebox of the image represented by display light 218.

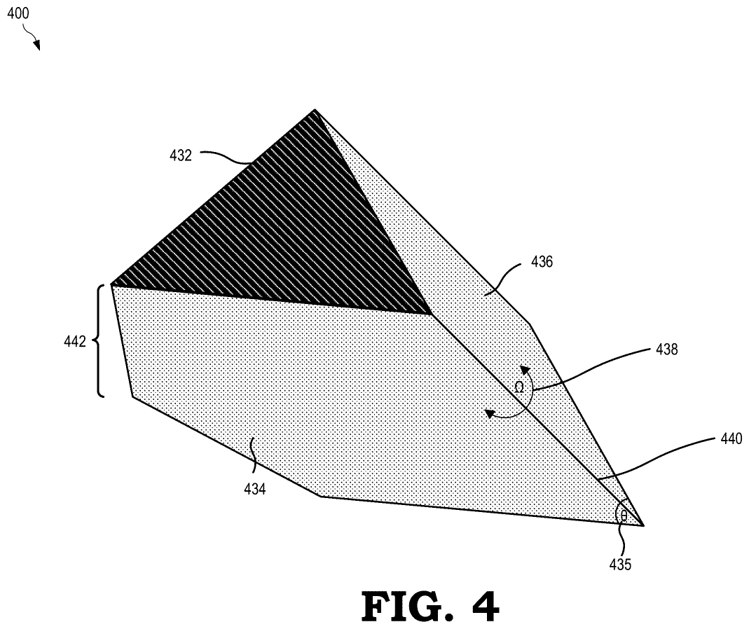

Referring now to FIG. 4, an example right-angle louver retroreflector 400 is presented, in accordance with embodiments. In embodiments, example right-angle louver retroreflector 400 is implemented in example lightguide 300 as one or more right-angle louver retroreflectors 330. Example right-angle louver retroreflector 400 is configured to reflect received light so as to expand the eyebox of a presented image and direct the light out of a lightguide (e.g., a lightguide implementing example right-angle louver retroreflector 400). For example, example right-angle louver retroreflector 400 includes a first reflective surface 434 configured to reflect light based on the angle of incidence at which the light was received at the first reflective surface 434. Such a first reflective surface 434, for example, includes a structure having at least one flat surface forming first reflective surface 434 made from plastic, glass, or the like. Further, to enable the first reflective surface 434 to reflect light, the first reflective surface 434 includes one or more reflective surfaces, reflective coatings (e.g., metallic coatings, multilayer dielectric coatings, mirrors (e.g., di-electric mirrors, metallic mirrors, Bragg facets), mirror coatings, or any combination thereof included in or disposed on the first reflective surface 434. As an example, the first reflective surface 434 is coated with one or more metal coatings, multiplayer dielectric coatings, or both that form a semitransparent mirror with a reflectivity between 3% and 50%. Additionally, right-angle louver retroreflector 400 includes a second reflective surface 436 configured to reflect light based on the angle of incidence at which the light was received at the second reflective surface 436. This second reflective surface 436, for example, includes a structure having at least one flat surface forming second reflective surface 436 made from plastic, glass, or the like. The second reflective surface 436 also includes one or more reflective surfaces, reflective coatings, mirrors (e.g., di-electric mirrors, metallic mirrors, Bragg facets), mirror coatings, or any combination thereof included in or disposed on the second reflective surface 436. For example, the second reflective surface 436 is coated with one or more metal coatings, multiplayer dielectric coatings, or both that form a semitransparent mirror with a reflectivity between 3% and 50%.

To form the example right-angle louver retroreflector 400, a side of the first reflective surface 434 is joined with a side second reflective surface 436 to form an edge 440 of the example right-angle louver retroreflector 400. Additionally, the side of the first reflective surface 434 is joined with the side second reflective surface 436 such that the angle between the first reflective surface 434 and the second reflective surface 436 relative to the edge 440 is substantially 90°. That is, the first side of the first reflective surface 434 is joined with the side of the second reflective surface 436 such that the first reflective surface 434 and the second reflective surface 436 function as if there is a right angle between the first reflective surface 434 and the second reflective surface 436. As an example, in some embodiments, the side of the first reflective surface 434 is joined with the side second reflective surface 436 such that the first reflective surface 434 and the second reflective surface 436 there is a 90° angle between the first surface 434 and the second surface 436 within 5 arcmins. According to embodiments, both the first reflective surface 434 and the second reflective surface 436 are configured to reflect (e.g., direct) received display light 218 based upon the angle upon which display light 218 is incident upon the first reflective surface 434 or the second reflective surface 436. For example, based on display light 218 being incident upon the first reflective surface 434 or the second reflective surface 436 at a first angle or an angle within a first range of angles, the first reflective surface 434 or the second reflective surface 436, respectively, is configured to reflect display light 218 in a first direction. As an example, the first reflective surface 434 or the second reflective surface 436 is configured to reflect display light 218 toward one or more other example right-angle louver retroreflectors 400 in the same array. Additionally, based on display light 218 being incident upon the first reflective surface 434 or the second reflective surface 436 at a second angle or an angle within a second range of angles, the first reflective surface 434 or the second reflective surface 436, respectively, is configured to reflect display light 218 in a second direction different from the first direction. As an example, the first reflective surface 434 or the second reflective surface 436 is configured to reflect display light 218 out of a lightguide 205 such that an exit pupil is formed.

According to embodiments, the first reflective surface 434 and the second reflective surface 436 are both configured to reflect light based on one or more parameters of example right-angle louver retroreflector 400. Such parameters include, for example, the height 442 of the example right-angle louver retroreflector 400, the roll angle 438 of the right-angle louver retroreflector 400, and the edge angle 435 of the example right-angle louver retroreflector 400. The height 442, for example, represents the dimension of the right-angle louver retroreflector 400 along an axis perpendicular to the surface upon which the right-angle louver retroreflector 400 is disposed. For example, the height 442 represents the dimension of the example right-angle louver retroreflector 400 along an axis perpendicular to the surface of a lightguide implementing the example right-angle louver retroreflector 400. According to some embodiments, the height 442 of the example right-angle louver retroreflector 400 is between 0.5 mm to 3.0 mm, with such a range being inclusive. The roll angle 438, represented in FIG. 4 as Ω, represents the angle of the right-angle louver retroreflector 400 is rotated with respect to edge 440 as to maintain the right angle between the first reflective surface 434 and the second reflective surface 436. Further, the edge angle 435 of the example right-angle louver retroreflector 400, represented in FIG. 4 as θ, represents the angle of the edge 440 relative to the surface of the lightguide 205 upon which the example right-angle louver retroreflector 400 is disposed. According to some embodiments, the edge angle 435 of example right-angle louver retroreflector 400 is between 20° to 70°, with such a range being inclusive. According to some embodiments, the first reflective surface 434 and the second reflective surface 436 of example right-angle louver retroreflector 400 are disposed within a lightguide (e.g., lightguide 205, example lightguide 300) such that a first portion (e.g., bottom portion) of the first reflective surface 434 and the second reflective surface 436 are cropped by a first surface (e.g., bottom TIR surface) of the lightguide. Further, the first reflective surface 434 and the second reflective surface 436 of example right-angle louver retroreflector 400 are disposed within a lightguide (e.g., lightguide 205, example lightguide 300) such that a second portion (e.g., top portion) of the first reflective surface 434 and the second reflective surface 436 are cropped by a second surface (e.g., top TIR surface) of the lightguide which forms a top surface 432 (e.g., non-reflective surface) of example right-angle louver retroreflector 400.

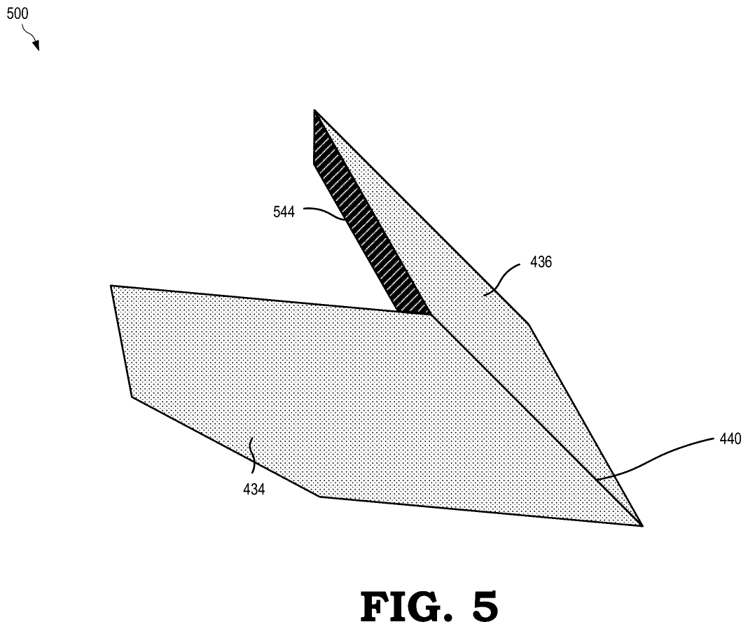

Referring now to FIG. 5, an example right-angle louver retroreflector 500 having a cutout is presented, in accordance with embodiments. In embodiments, example right-angle louver retroreflector 500 is implemented in example lightguide 300 as one or more right-angle louver retroreflectors 330 and is similar to example right-angle louver retroreflector 400. For example, to help improve the efficiency and uniformity of light extraction by example right-angle louver retroreflector 500, example right-angle louver retroreflector 500 includes a cutout forming respective back surfaces 544 for both the first reflective surface 434 and the second reflective surface 436. As an example, when compared to example right-angle louver retroreflector 400, example right-angle louver retroreflector 500 includes at least a portion of top surface 432 removed resulting in a cutout at the top of right-angle louver retroreflector 500 that forms respective back surfaces 544 for both the first reflective surface 434 and the second reflective surface 436. Such back surfaces 544, for example, include a non-reflective surface covering a side (e.g., a side representing the thickness) of the first reflective surface 434 or the second reflective surface 436. In embodiments, the angle of such a back surface 544 relative to the first reflective surface 434 or the second reflective surface 436 first is between 0° and 30° with such a range being inclusive. Because the back surfaces 544 of example right-angle louver retroreflector 500 are smaller than the top surface 432 of example right-angle louver retroreflector 400, example right-angle louver retroreflector 500 is smaller than right-angle louver retroreflector 400. As such, right-angle louver retroreflector 500 allows for tighter packing with an array, allowing for more efficient and uniform light extraction by the array.

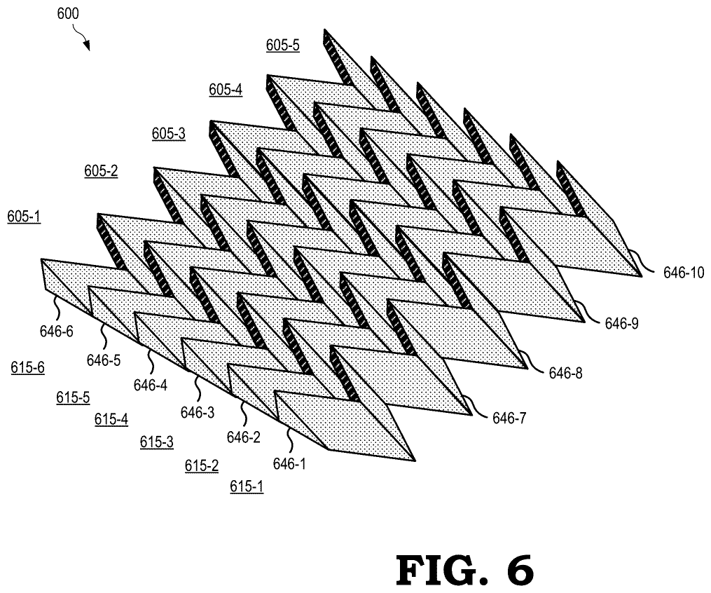

Referring now to FIG. 6, an example array 600 of right-angle louver retroreflectors for a combined exit pupil expansion and outcoupling structure is presented, in accordance with some embodiments. In embodiments, example array 600 is implemented within the combined exit pupil expansion and outcoupling structure 224 of a lightguide (e.g., lightguide 205, example lightguide 300). According to embodiments, example array 600 includes a number of right-angle louver retroreflectors 646, similar to or the same as right-angle louver retroreflectors 330, 400, 500, arranged in one or more rows 615 and one or more columns 605. For example, example array 600 includes a first row 615-1 formed from right-angle louver retroreflectors 646-1, 646-7, 646-8, 646-9, 646-10 and a first column 605-1 formed from right-angle louver retroreflectors 646-1, 646-2, 646-3, 646-4, 646-5, 646-6. Though the example embodiment presented in FIG. 6 shows example array 600 as including six rows (615-1, 615-2, 615-3, 615-4, 615-6) and five columns (605-1, 605-2, 605-3, 605-4, 605-5), in other embodiments, example array 600 can include any non-zero integer number of rows and any non-zero integer number of columns. In some embodiment, the number of rows 615 in example array 600 may differ from the number of columns 605 in example array 600. Additionally, though the example embodiment presented in FIG. 6 shows each row 615 of example array 600 as including five right-angle louver retroreflectors 646 and each column 605 as including six right-angle louver retroreflectors 646, in other embodiments, each row 615 of example array 600 can include any non-zero integer number of right-angle louver retroreflectors 646 and each column 605 of example array 600 can include any non-zero integer number of right-angle louver retroreflectors 646. According to some embodiments, the number of right-angle louver retroreflectors 646 in each row 615 of example array 600 differs from the number of right-angle louver retroreflectors 646 in each column 605 of example array 600.

Within example array 600, each right-angle louver retroreflector 646 is arranged such that the first reflective surface 434 of each right-angle louver retroreflector 646 is parallel to the first reflective surface 434 of each other right-angle louver retroreflector 646 in example array 600. Additionally, each right-angle louver retroreflector 646 is arranged such that the second reflective surface 436 of each right-angle louver retroreflector 646 is parallel to the second reflective surface 436 of each other right-angle louver retroreflector 646 in example array 600. According to embodiments, within each row 615 of example array 600, each right-angle louver retroreflector 646 is arranged such that at least a portion of one reflective surface (e.g., first reflective surface 434, second reflective surface 436) is in contact with at least a portion of one reflective surface of another right-angle louver retroreflector 646 within the row 615. Referring to the example embodiment presented in FIG. 6, within row 615-1, a second reflective surface 436 of right-angle louver retroreflector 646-1 is in contact with a first reflective surface 434 of right-angle louver retroreflector 646-7. Further, within row 615-1, the second reflective surface 436 of right-angle louver retroreflector 646-7 is in contact with the first reflective surface 434 of right-angle louver retroreflector 646-8. Additionally, within each column 605 of example array 600, each right-angle louver retroreflector 646 is arranged such that at least a portion of the right-angle louver retroreflector 646 covers at least a portion of another right-angle louver retroreflector 646 in the column 605, is covered by at least a portion of another right-angle louver retroreflector 646 in the column 605, or both. As an example, each right-angle louver retroreflector 646 is arranged such that at least a bottom portion of the right-angle louver retroreflector 646 is covered by another right-angle louver retroreflector 646 in the column 605, the right-angle louver retroreflector 646 covers at least a bottom portion of another right-angle louver retroreflector 646 in the column, or both. Referring to the example embodiment in FIG. 6, within column 605-1, at least a portion (e.g., bottom portion) of right-angle louver retroreflector 646-2 is covered by right-angle louver retroreflector 646-1 such that the portion of right-angle louver retroreflector 646-2 is obscured in a top-down view of example array 600. Further, right-angle louver retroreflector 646-2 covers at least a portion of right-angle louver retroreflector 646-3 such that the portion of right-angle louver retroreflector 646-3 is obscured in a top-down view of example array 600.

According to embodiments, at least a portion of each right-angle louver retroreflector 646 of example array 600 is fabricated via injection molding, casting, or both and then coated to form a reflective surface. Further, in some embodiments, example array 600 is not periodic. For example, according to some embodiments, example array 600 includes one or more right-angle louver retroreflectors 646 including one or more parameters (e.g., height 442, edge angle 435, roll angle 438) that differ from the parameters of one or more other right-angle louver retroreflectors 646 in example array 600.

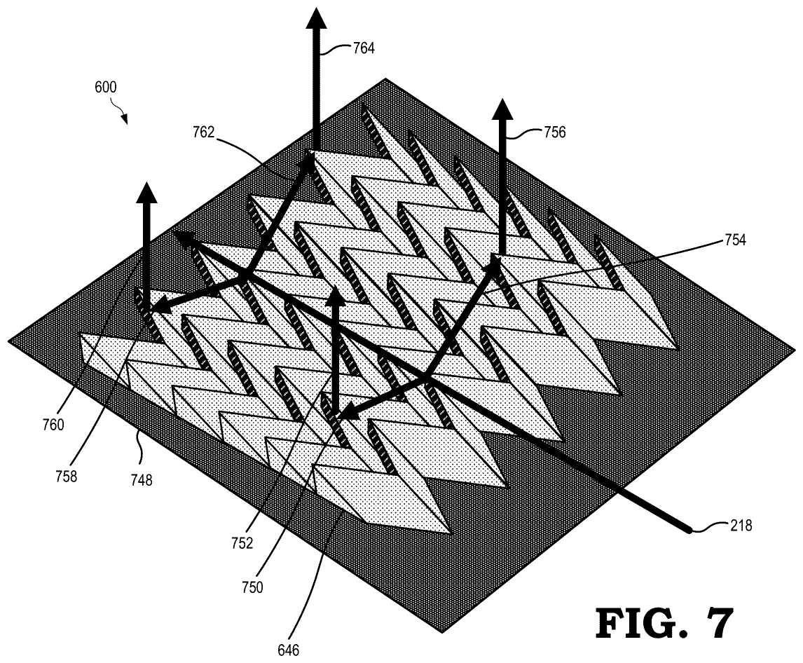

Referring now to FIG. 7, a diagram of display light reflecting within an example array of right-angle louver retroreflectors is presented, in accordance with embodiments. According to embodiments, FIG. 7 demonstrates at least a portion of display light 218, as emitted by an optical engine 202, reflecting within example array 600. For example, in embodiments, display light 218 is configured to propagate through a lightguide (e.g., lightguide 205, example lightguide 300) implementing example array 600 via TIR, PIR, or both. For example, display light 218 bounces off one or more surfaces 748 of the lightguide so as to propagate via TIR toward example array 600. Display light 218 is then received by example array 600 such that display light 218 is first incident upon a first right-angle louver retroreflector 646 and right-angle louver retroreflector 646 in a first row 615-1 at a first angle or an angle within a first range of angles. Due to display light 218 being incident upon these right-angle louver retroreflectors 646 at a first angle or an angle within a first range of angles, the first right-angle louver retroreflector 646 directs a first portion 750 in a first direction toward a first right-angle louver retroreflector 646 in the second row 615-2 of example array 600. Further, the second right-angle louver retroreflector 646 directs a second portion 754 in a second direction different from the first direction toward a second right-angle louver retroreflector 646 in the second row 615-2 of example array 600. The first portion 750 of display light 218 then travels within example array 600 until it is incident upon the first right-angle louver retroreflector 646 in the second row 615-2 at a second angle or an angle within a second set of angles. Due to the first portion 750 being incident at a second angle or an angle within a second set of angles, the first right-angle louver retroreflector 646 in the second row 615-2 directs the first portion 750 out of the lightguide such that the first portion 750 forms a first exit pupil (represented in FIG. 7 as exit beam 752). Further, the second portion 754 of display light 218 travels until it is incident upon the second right-angle louver retroreflector 646 in the second row 615-2 at a second angle or an angle within a second set of angles. The second right-angle louver retroreflector 646 in the second row 615-2 then directs the second portion 754 out of the lightguide such that the second portion 754 forms a second exit pupil (represented in FIG. 7 as exit beam 756).

Additionally, at least a portion of display light 218 continues to travel within example array 600 until the portion of display light 218 is incident upon a first right-angle louver retroreflector 646 and second right-angle louver retroreflector 646 in the fifth row 615-5 at the first angle or an angle within the first range of angles. Based on the portion of display light 218 being incident upon the first right-angle louver retroreflector 646 in the fifth row 615-5 at the first angle or an angle within the first range of angles, the first right-angle louver retroreflector 646 in the fifth row 615-5 reflects a third portion 758 of display light 218 toward a first right-angle louver retroreflector 646 in the sixth row 615-6 of example array 600 such that the third portion 758 is incident upon this first right-angle louver retroreflector 646 in the sixth row 615-6 at the second angle or an angle within the second range of angles. The first right-angle louver retroreflector 646 in the sixth row 615-6 then directs the third portion 758 out of the lightguide such that the third portion forms a third exit pupil (represented in FIG. 7 as exit beam 760). Further, in response to the portion of display light 218 being incident upon the second right-angle louver retroreflector 646 in the fifth row 615-5 at the first angle or an angle within the first range of angles, the second right-angle louver retroreflector 646 in the fifth row 615-5 reflects a fourth portion 762 of display light 218 toward a second right-angle louver retroreflector 646 in the sixth row 615-6 of example array 600 such that the fourth portion 762 is incident upon this second right-angle louver retroreflector 646 in the sixth row 615-6 at the second angle or an angle within the second range of angles. The second right-angle louver retroreflector 646 in the sixth row 615-6 then directs the fourth portion 762 out of the lightguide such that the fourth portion 762 forms a fourth exit pupil (represented in FIG. 7 as exit beam 764). Though the example embodiment presented in FIG. 7 shows the example array 600 as producing four exit pupils (represented by exit beams 752, 756, 760, 764), in other embodiments, example array 600 is configured to produce any non-zero integer number of exit pupils so as to expand the eyebox of the image.

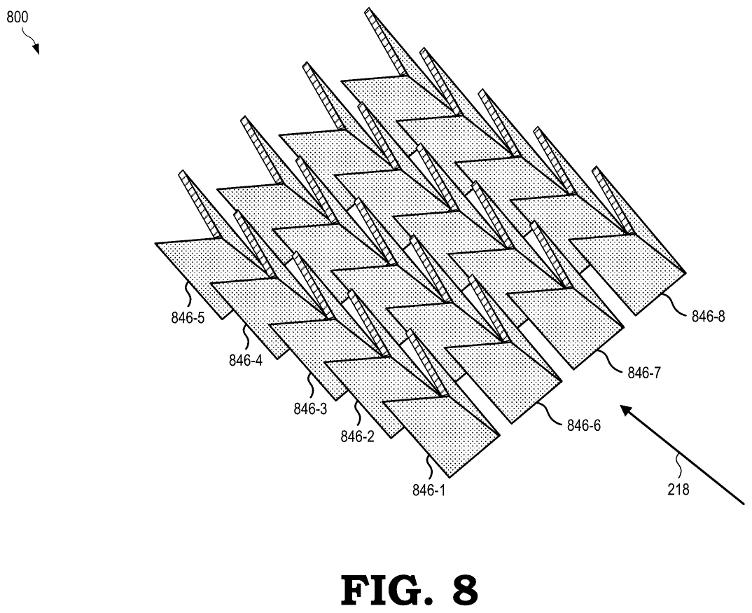

Referring now to FIG. 8, an example array 800 of rotated right-angle louver retroreflectors for a combined exit pupil expansion and outcoupling structure of a lightguide is presented, in accordance with some embodiments. In embodiments, example array 800 is implemented within the combined exit pupil expansion and outcoupling structure 224 of a lightguide (e.g., lightguide 205, example lightguide 300). According to embodiments, example array 800 includes a number of right-angle louver retroreflectors 846, similar to or the same as right-angle louver retroreflectors 330, 400, 500, 646 arranged in one or more rows and one or more columns. For example, a first row of example array 800 includes right-angle louver retroreflectors 846-1, 846-6, 846-7, 846-8 and a first column of example array 800 includes right-angle louver retroreflectors 846-1, 846-2, 846-3, 846-4, 846-5. Though the example embodiment presented in FIG. 8 shows example array 800 as including five rows and four columns, in other embodiments, example array 800 can include any non-zero integer number of rows and any non-zero integer number of columns. In some embodiments, the number of rows in example array 800 may differ from the number of columns in example array 800. Additionally, though the example embodiment presented in FIG. 8 shows each row of example array 800 as including four right-angle louver retroreflectors 846 and each column as including five right-angle louver retroreflectors 846, in other embodiments, each row of example array 800 can include any non-zero integer number of right-angle louver retroreflectors 846 and each column of example array 800 can include any non-zero integer number of right-angle louver retroreflectors 846. According to some embodiments, the number of right-angle louver retroreflectors 846 in each row of example array 800 differs from the number of right-angle louver retroreflectors 846 in each column of example array 800.

Within example array 800, each right-angle louver retroreflector 846 is arranged such that the first reflective surface 434 of the right-angle louver retroreflector 846 is parallel to the first reflective surface 434 of each other right-angle louver retroreflector 846 in example array 800 and such that the second reflective surface 436 of the right-angle louver retroreflector 846 is parallel to the second reflective surface 436 of each other right-angle louver retroreflector 846 in example array 800. As well, within example array 800, the roll angle 438 of each right-angle louver retroreflector 846 is rotated from a zero position such that the edge 440 of each right-angle louver retroreflector 846 is not in line with display light 218 received by example array 800. That is, the roll angle 438 of each right-angle louver retroreflector 846 is rotated from a zero position such that the edge 440 of each right-angle louver retroreflector 846 is oblique to display light 218 received by example array 800. By rotating the roll angle 438 of the right-angle louver retroreflectors 846, the likelihood of stray beams exiting the example array 800 and causing ghost images visible to the eye 222 of the user is reduced, improving user experience. In some embodiments, example array 800 is not periodic. For example, according to some embodiments, example array 800 includes one or more right-angle louver retroreflectors 846 including one or more parameters (e.g., height 442, edge angle 435, roll angle 438) that differ from the parameters of one or more other right-angle louver retroreflectors 846 in example array 800.

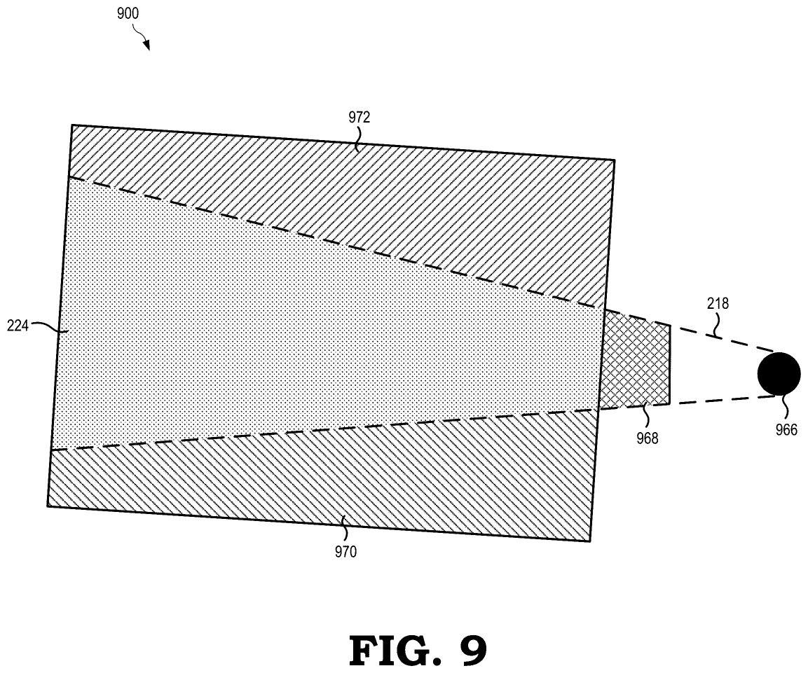

Referring now to FIG. 9, an example layout 900 for a lightguide including a combined exit pupil expansion and outcoupling structure is presented, in accordance with some embodiments. In embodiments, example layout 900 is implemented within lightguide 205, example lightguide 300, or both. Within example layout 900, display light 218 propagates through a lightguide via TIR, PIR, or both and forms an input pupil 966. From the input pupil 966, display light 218 continues to travel in the lightguide until it is received by an area of a lightguide including EPE 968, combined exit pupil expansion and outcoupling structure 224, first one-dimensional outcoupling structure 970, second one-dimensional outcoupling structure 972, or any combination thereof. For example, according to embodiments, display light 218 is first received by EPE 968 configured to expand the eyebox of the image represented by display light 218 by splitting display light 218 into one or more beams. From EPE 968, display light 218, one or more split beams representing display light 218, or both are received by combined exit pupil expansion and outcoupling structure 224. Combined exit pupil expansion and outcoupling structure 224 is configured to split display light 218, one or more split beams representing display light 218, or both into additional split beams. Further, combined exit pupil expansion and outcoupling structure 224 is configured to outcouple at least a portion of these split beams out of the lightguide such that these outcoupled split beams form exit pupils representing the image. Additionally, in some embodiments, combined exit pupil expansion and outcoupling structure 224 is configured to direct a first portion of these split beams to a first one-dimensional outcoupling structure 970 and a second portion of these split beams to a second one-dimensional outcoupling structure 972. In response to receiving split beams from combined exit pupil expansion and outcoupling structure 224, both the first one-dimensional outcoupling structure 970 and the second one-dimensional outcoupling structure 972 are configured to direct the split beams out of the lightguide such that the split beams form additional exit pupils.

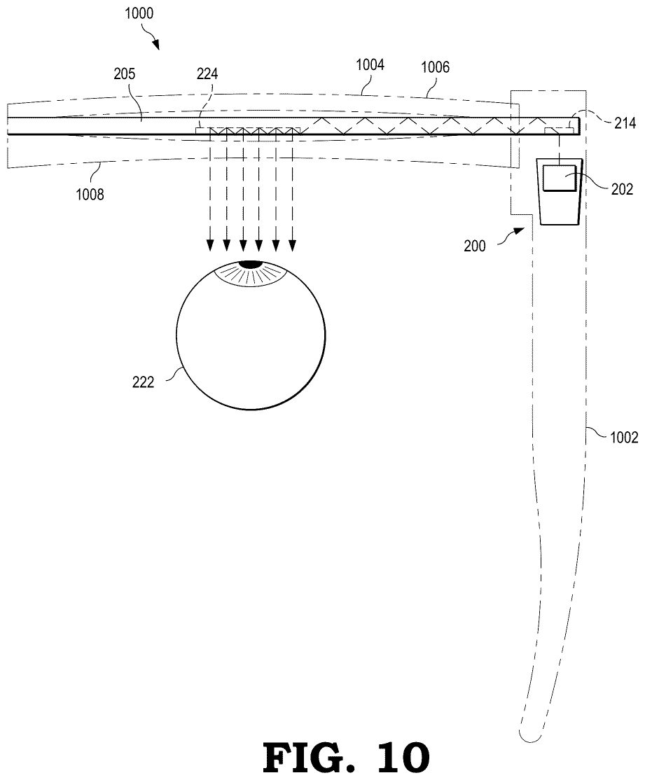

Referring now to FIG. 10, FIG. 10 illustrates a portion of an eyewear display 1000 that includes the lightguide 205 of FIG. 2, the example lightguide 300 of FIG. 3, or both. In some embodiments, the eyewear display 1000 represents the display system 100 of FIG. 1. The optical engine 202, the incoupler 214, the combined exit pupil expansion and outcoupling structure 224, and a portion of the lightguide 205 are included in an arm 1002 of the eyewear display 1000, in the present example.

The eyewear display 1000 includes an optical combiner lens 1004, which includes a first lens 1006, a second lens 1008, and the lightguide 205, with the lightguide 205 disposed between the first lens 1006 and the second lens 1008. Light exiting through the combined exit pupil expansion and outcoupling structure 224 travels through the second lens 1008 (which corresponds to, for example, the lens element 110 of the display system 100) before forming exit pupils that expand the eyebox of an image represented by the light. In use, the light exiting second lens 1008 enters the pupil of an eye 222 of a user wearing the eyewear display 1000, causing the user to perceive a displayed image carried by the display light output by the optical engine 202. The optical combiner lens 1004 is substantially transparent, such that light from real-world scenes corresponding to the environment around the eyewear display 1000 passes through the first lens 1006, the second lens 1008, and the lightguide 205 to the eye 222 of the user. In this way, images or other graphical content output by the projection system 200 is combined (e.g., overlayed) with real-world images of the user's environment when projected onto the eye 222 of the user to provide an AR experience to the user. Although not shown in the depicted example, in some embodiments additional optical elements are included in any of the optical paths between the optical engine 202 and the incoupler 214, in between the incoupler 214 and the combined exit pupil expansion and outcoupling structure 224, and/or in between the combined exit pupil expansion and outcoupling structure 224 and the eye 222 of the user (e.g., in order to shape the display light for viewing by the eye 222 of the user).

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A lightguide, comprising:
an incoupler configured to direct display light representative of an image into a body of the lightguide; and
a combined exit pupil expansion and outcoupling structure including an array of louver retroreflectors configured to expand an eyebox of the image and direct at least a portion of the display light out of the lightguide, wherein each louver retroreflector of the array of louver retroreflectors includes a first reflective surface and a second reflective surface, the first reflective surface arranged substantially orthogonal to the second reflective surface.

2. The lightguide of claim 1, wherein, for each louver retroreflector of the array of louver retroreflectors, a side of the first reflective surface is joined with a side of the second reflective surface to form an edge of the louver retroreflector.

3. The lightguide of claim 2, wherein each louver retroreflector of the array of louver retroreflectors includes a top surface having a cutout.

4. The lightguide of claim 1, wherein each louver retroreflector of the array of louver retroreflectors is arranged such that the first reflective surface of the louver retroreflector is parallel to the first reflective surface of each other louver retroreflector of the array of louver retroreflectors.

5. The lightguide of claim 1, wherein one or more louver retroreflectors of the array are arranged so as to cover at least a portion of one or more other retroreflectors of the array.

6. The lightguide of claim 1, wherein at least one selected from a group of a height, roll angle, or edge angle of a first louver retroreflector of the array of louver retroreflectors different from the at least one selected from a group of a height, roll angle, or edge angle of a second louver retroreflector of the array of louver retroreflectors.

7. The lightguide of claim 1, wherein the array of louver retroreflectors is configured to split the display light into two or more portions and direct the two or more portions out of the lightguide.

8. The lightguide of claim 1, wherein the lightguide further includes:
a one-dimensional outcoupling structure configured to direct light received from the combined exit pupil expansion and outcoupling structure out of the lightguide.

9. A head-wearable display (HWD), comprising:
an optical engine configured to emit display light representative of an image; and
a lightguide including a combined exit pupil expansion and outcoupling structure that includes an array of louver retroreflectors configured to expand an eyebox of the image and direct at least a portion of the display light out of the lightguide, wherein each louver retroreflector of the array of louver retroreflectors includes a first reflective surface and a second reflective surface, the first reflective surface arranged substantially orthogonal to the second reflective surface.

10. The HWD of claim 9, wherein, for each louver retroreflector of the array of louver retroreflectors, a side of the first reflective surface is joined with a side of the second reflective surface to form an edge of the louver retroreflector.

11. The HWD of claim 9, wherein each louver retroreflector of the array of louver retroreflectors is arranged such that the first reflective surface of the louver retroreflector is parallel to the first reflective surface of each other louver retroreflector of the array of louver retroreflectors.

12. The HWD of claim 9, wherein one or more louver retroreflectors of the array are arranged so as to cover at least a portion of one or more other retroreflectors of the array.

13. The HWD of claim 9, wherein at least one selected from a group of a height, roll angle, or edge angle of a first louver retroreflector of the array of louver retroreflectors different from the at least one selected from a group of a height, roll angle, or edge angle of a second louver retroreflector of the array of louver retroreflectors.

14. The HWD of claim 9, wherein the array of louver retroreflectors is configured to split the display light into two or more portions and direct the two or more portions out of the lightguide.

15. The HWD of claim 9, wherein each louver retroreflector of the array of louver retroreflectors includes a top surface having a cutout.

16. The HWD of claim 9, wherein the lightguide further includes:
a one-dimensional outcoupling structure configured to direct light received from the combined exit pupil expansion and outcoupling structure out of the lightguide.

17. A lightguide, comprising:
one or more reflective structures configured to direct display light representative of an image into a body of the lightguide; and
an array of louver retroreflectors configured to expand an eyebox of the image and direct at least a portion of the display light out of the lightguide, wherein each louver retroreflector of the array of louver retroreflectors includes a first reflective surface and a second reflective surface, the first reflective surface arranged substantially orthogonal to the second reflective surface.

18. The lightguide of claim 17, wherein each louver retroreflector of the array of louver retroreflectors includes a top surface having a cutout.

19. The lightguide of claim 17, wherein each louver retroreflector of the array of louver retroreflectors is arranged such that the first reflective surface of the louver retroreflector is parallel to the first reflective surface of each other louver retroreflector of the array of louver retroreflectors.

20. The lightguide of claim 17, wherein the lightguide further includes:
a one-dimensional outcoupling structure configured to direct light received from the array of louver retroreflectors out of the lightguide.
